(19) United States
(12) Patent Application Publication
(10) Pub. No.: US 2008/0311233 A1
(43) Pub. Date: Dec. 18, 2008

(54) Naturally Occurring Phenolic Substances Useful as Pesticides

(76) Inventor: Yoram Tsivion, Pardes Hanna (IL)

Correspondence Address: YORAM TSIVION, P.O. BOX 1307, PARDES HANNA, 37111, IL

(21) Appl. No.: 11/568,327

(22) PCT Filed: Apr. 20, 2005
(86) PCT No.: PCT/IL05/00415

§ 371 Date: Oct. 26, 2006

(30) Foreign Application Priority Data
Apr. 26, 2004 (GB) 0409205.2
Jun. 24, 2004 (GB) 0414153.7

(51) Int. Cl. A01N 35/04; A01N 65/00

(52) U.S. Cl. 424/754; 514/699

(57) ABSTRACT

Two phenolic compounds occurring in nature were useful in the control of some pests. Salicylaldehyde is a substance produced by some plants and some animals. A novel pest control agent is based on salicylaldehyde. It is active against caterpillars (larvae of butterflies and moths) as well as earthworms and molluscs. In combination with garlic extract it enhances the activity of such extract. An agent for the control of insects in agriculture comprises vanillin. The vanillin powder is solubilised in water for spraying onto insects infesting crops.

### TECHNICAL FIELD OF THE INVENTION

The present invention relates to means for controlling invertebrate pests such as insects, slugs, caterpillars and worms. More specifically the invention deals with naturally occurring chemical compositions for controlling such pests in the agricultural fields.

### BACKGROUND OF THE INVENTION

In the agricultural practice synthetic toxic agents are used to reduce the population of harmful insects in the crops. Typical chemical agents employed in the composition of such agents are organophosphorous and carbamate compounds. The toxicity associated with such substances is often harmful to the environment and to the consumers of food products produced from the crops. To facilitate cultivation of crops and yet keep the harmful effect low, chemical agents having reduced toxicity have been introduced to control pests. For example, the application of plant essential oils to combat beetles in packages of food products disclosed in US patent application publication US 2003/0091661A1.

Slugs and snails cause damages to agricultural set ups and gardens by consuming vegetative material. To combat molluscs, more or less specific poisons are distributed in localities in which the pests thrive. Metaldehyde which is tetramer of acetaldehyde is an effective mollusc poison but is also quite toxic to mammals and birds. Metiocarb is a carbamate also widely used and is also toxic at least to mammals. Salts of metals and chelates of metals, such as aluminium or heavy metals are also effective as mollusc poison, for example as disclosed in WO 9605728A1.

Earthworms are usually not classified as pests, but for the maintenance and use of turf grass fields and especially golf courses their effect may be disadvantageous. They create small mounds of ingested soil called castings, which interferes with the workability and playability of the turf grass field. As of today, there does not seem to be a well established chemical control agent for earthworms, may be partially because in the registration process the damaged caused by candidate pesticides to earthworms is considered a drawback (Donald Lewis, Department of Entomology, Iowa State University, Ames, Iowa, in “Horticulture and Home Pest News” Apr. 14, 1995, p. 47)

Butterfly and moth larva (caterpillars) are oftentimes considered as pests notably by the sheer consummation of a large amount of plant material. Other than synthetic poisons for controlling such pests, there are several natural chemical agents used. Some are biological origin such as BT (Bacillus thuringinensis) or spinosad. Soaps can also be used for the control of caterpillars.

Salicylaldehyde is a naturally occurring substance. In some plants and plant parts its concentration is considerable. It has been shown by Pasteels J M and J C Gregoire, 1983 (The chemical ecology of defense in Arthropods, Ann Rev Entomol 28:263-289) that larvae of the chrysomelid tribe Phaedomini secret salicylaldehyde. The salicylaldehyde is used as a natural repellent by the feeding beetle against small predators such as ants. The salicylaldehyde is produced by the larvae from salicin, a glucoside, which is extracted by the larvae from the host plant, and further used to produce salicylaldehyde by the feeding beetle.

### DETAILED DESCRIPTION OF THE PRESENT INVENTION

Salicylaldehyde was used as described below to control several types of pests.

Preparation of Materials for Experiments

Component A: Agral® 90 (nonyl phenoxy polyethoxy ethanol) surfactant.

Component B: Garlic extract supplied by Omex Agriculture of Estuary Road, King's Lynn, Norfolk, England.

Mixture A: Twenty five (25) mls (milli-liters) of salicylaldehyde (2-Hydroxybenzaldehyde) (Sigma-Aldrich) were mixed with 17 ml of component A. A clear stable solution forms.

Mixture B: 75 mls of component B were mixed thoroughly with 25 mls of mixture A.

Results of October 2003 Field Experiments in England:

Caterpillars:

Cabbage white fly (Pieris rapae) caterpillars of various sizes were collected in the field. 0.5 percent in water of mixture A were hand sprayed to full coverage on caterpillars, with constant agitation of sprayer during spraying. Seven out of seven caterpillars died within ten minutes.

Diamondback moth (Plutella xylostella) larvae of various sizes were collected in the field. 0.5 percent in water of mixture A were hand sprayed to full coverage on caterpillars, with constant agitation of sprayer during spraying. Eleven out of 11 died within ten minutes.

Molluscs

A few dozens of slugs belonging to two species: grey field slug (Deroceras reticulatum) and black slug (Arion ater) were collected and placed in exposed ground site. The slugs were hand sprayed with 0.5 percent in water of mixture A to full coverage of slugs, with constant agitation of sprayer during spraying. All slugs died within about 15 to 20 minutes, and were observed after one day to ensure trueness of observation.

Results of April 2004 Laboratory Experiments:

Molluscs

Grey field slug were collected from soil and placed in perspex containers (22 cm length, 11 cm width, 8 cm deep). Three slugs were placed in each of the containers and covered in very coarse soil. There were three replicates per treatment. 50 mls of each of the following treatments was then applied as an aqueous drench: water (control), 0.5 percent in water of mixture B and 0.25 percent in water of component A. The containers were assessed twenty-four hours after treatment application. The results are shown table 1 as follows:

TABLE 1

| | Mean % (± sd) of dead slugs | |
|---|---|---|
| Treatments | 24 hours after application | |
| Water | 0.0 | (0.0) |
| Mixture B (0.5%) | 100.0 | (0.0) |
| Component A (0.25%) | 11.1 | (19.2) |

The effect of the surfactant (component A), though not negligible was due to one dead specimen that caused a large standard deviation in the statistical calculation. A further assessment 48 hours after treatment showed there was no change in the results.

Earthworms

Worms (Lumbricus terrestris) were collected from soil and placed in large ventilated Petri dishes (15 cm diameter, 4 cm deep). The worms were then covered in soil (4 cm, depth). Three worms were placed in each dish and there were three replicates per treatment. 25 mls of each of the following treatments was then applied as an aqueous drench: water (control), component B (3% emulsified in water), mixture B (0.5% in water) and component A (0.25%).

The Petri dishes were assessed twenty-four hours after treatment application. The results in table 2 show that the mixture B produced the highest mortality of all the treatments (88.9%). Component B produced a mortality rate in worm numbers of 55.6% although it was six times more concentrated in the drench than Mixture B. Component A did not kill any worm.

TABLE 2

| | Mean % (± sd) of dead worms | |
|---|---|---|
| Treatments | 24 hours after application | |
| Water | 0.0 | (0.0) |
| Component B (3.0%) | 55.6 | (38.5) |
| Mixture B (0.5%) | 88.9 | (19.2) |
| Component A (0.25%) | 0.0 | (0.0) |

The dishes were also assessed 48 hours after treatment but there was no further change in the results.

Formulations:

Salicylaldehyde mixes only to a very small extent in water. To effectively enhance the mixing in water it is required to mix the agent with at least a surfactant. The Agral® nonionic surfactant effectively mixes with salicylaldehyde forming a seemingly real solution, and as described above, is useful as a surfactant for the compositions of the invention. Tetra ethyl ortho-silicate mixes effectively with salicylaldehyde and can be used as a dispersant of the salicylaldehyde in water and as a filler, in addition to a surfactant. Liquid polyethylene glycol (PEG 400, Sigma Aldrich) mixes effectively with salicylaldehyde, and can also be used as a formulating agent as a filler and dispersant.

Vanillin was used as described below to control several types of pests. All the experiments described hereinafter were carried out using solution A. This solution included vanillin solubilized in water. Treatments were performed using a hand sprayer with no specified properties.

Preparation of Solution A:

Vanillin in the form of powder (Sigma-Aldrich) was immersed in tap water, at the concentration of 0.3 grams of vanillin per 100 milliliters of water. The mixture was stirred for about 20 minutes using a magnetic stirrer until the powder appeared to be completely solubilised. No surfactant was added in order to avoid the direct involvement of the surfactant in the experiment.

Experiments

Heteropteran bugs belonging to the genus Dionconotus cruentatus feeding on Clivia flowers were collected in early March 2003, and also in early March 2004. Experiments were conducted on the two occasions respectively, immediately after the bugs were collected. In March 2003, 7 bugs were collected and put in an opened top box. The bugs were sprayed carefully because of the lack of surfactant, making sure that the each bug was fully covered by the sprayed liquid. Each bug was sprayed individually. The results were that each bug sprayed died after a few minutes since time of spraying. One day after, another 5 bugs were collected, and each sprayed using a freshly prepared solution A. All bugs died. The dead bugs were collected and visited after two days proving their mortality. The same experiment was repeated in March 2004 using 12 bugs. All these bugs were sprayed using a freshly prepared spray. The results were as in the year before. All died as a result of the spraying.

In March 2004 green aphids of the species Hyalopterus pruni in colonies feeding on the lower side of the leaf blades of peach were inspected. Eleven infected leaves were marked and sprayed carefully to insure the immersion of the entire aphid colony in the aqueous liquid devoid of any surfactant. Spraying was performed in the morning, and the sprayed leaves were visited a day after. Almost all aphids sprayed had cleared the leaves. Unsprayed infected leaves had their aphids colonies intact.

Several nocturnally active slugs, molluscs of the genus Limax were sprayed individually in situ at night without collecting or otherwise handling, using freshly prepared solution A. The spraying did not substantially effect the slugs, although they seemed stunned for a few minutes, after a while they resumed moving about and foraging.

### CONCLUSION

Vanillin at the indicated concentration in water was found to have a lethal effect on two insect species belonging to distinct taxonomic groups. Application of a composition including vanillin in the open air in agricultural circumstances is a convenient and effective insect control practice. The inclusion of agriculturally accepted surfactants and other formulating agents is expected to reduce the amount of active substance required for achieving the desired effect.

Formulation

The experiments presented hereinabove showed that the pure vanillin immersed in water is active in the concentration used as an insecticide. The experiments did not use agriculturally accepted surfactant or any surfactant since such agents are known to have effect on insects. Vanillin is not an oil and according to the Merck index (Merck & Co., Inc., 1899) is soluble to the extent of 1 gram in 100 ml water. It is more soluble in alcohol, and soluble in other organic solvents.

Vanillin was found to be considerably soluble in polyethylene glycol and in tetra ethyl ortho silicate.

1. A composition for the control of pests, comprising a mixture of salicylaldehyde and a suitable surfactant.

2. A composition as in claim 1 wherein said pests are slugs.

3. A composition as in claim 1 wherein said pests are earthworms.

4. A composition as in claim 1 wherein said pests are selected from the group consisting of larvae of butterfly and moth.

5. A composition as in claim 1, applied dispersed in water.

6. A composition for the control of pests, comprising a mixture of salicylaldehyde, a suitable surfactant and garlic extract.

7. A composition for the control of insects comprising vanillin dispersed in water.

8. A composition as in claim 7 for the control of aphids.

9. A composition as in claim 7 for the control of heteroptera.
